(19) United States
(12) Patent Application Publication
(10) Pub. No.: US 2015/0113050 A1
(43) Pub. Date: Apr. 23, 2015

(54) FINDING AND USING SERVERS FOR CERTAIN SERVICES

(71) Applicant: Karl Erik Stahl, Sundbyberg (SE)

(72) Inventor: Karl Erik Stahl, Sundbyberg (SE)

(21) Appl. No.: 14/520,227

(22) Filed: Oct. 21, 2014

Related U.S. Application Data
(60) Provisional application No. 61/893,717, filed on Oct. 21, 2013.

(51) Int. Cl. H04L 29/08; H04L 12/707

(52) U.S. Cl. CPC H04L 67/10; H04L 45/22
USPC 709/203

(57) ABSTRACT

A specific address of a server in a data communication network is found when using anycast addressing defined for available servers that provide a predetermined service by providing a first server having a memory and a processor coupled to the memory, sending a request from a client to use the first server for the predetermined service by the anycast address of the service, receiving the request at the first server and detecting that the request was addressed using an anycast address, and sending a response to the client, instructing the client to use an alternative server and providing a specific address of the alternative server to the client, instead of providing the requested predetermined service by the first server in response to the request.

### CROSS-REFERENCE TO RELATED APPLICATIONS

This application is based upon and claims the benefit of priority to US Provisional Application Ser. No. 61/893,717, filed Oct. 21, 2013, the disclosure of which is incorporated herein by reference in its entirety.

### BACKGROUND

1. Field

This method, telecommunication device, system or software module relates generally to the field of telecommunication.

2. Description of the Related Art

There are services provided servers in data communication network like the Internet. For real-time communication, e.g. telephony or multimedia communication, STUN (Session Traversal Utilities for NAT, RFC 5389) and TURN (Traversal Using Relays around NAT, RFC 5766) servers.

STUN and TURN servers are used to assist real-time traffic, the media data streams resulting from a call over the Internet, to traverse NATs (Network Address Translation) and firewalls in the network.

The address of available servers can be configured in a telecommunication device or software, or it can be supplied an application or service. There is often also a need to automatically find the address, to discover, of a certain type of servers available in a network, e.g. DNS, STUN and TURN servers. DNS (Domain Name System) servers are one example, where the addresses of DNS servers are provided by e.g. DHCP (Dynamic Host Configuration Protocol) and several other methods at different network accesses.

There are yet no standardized methods for discovering STUN and TURN servers. DHCP could be used, but may require changes in existing infrastructure and is not available in all network types. Service discovery based on DNS also exists, but require extensive provisioning and may have other limitations or drawbacks.

IP (Internet Protocol) anycast (RFC 4786) could be another solution for server discovery. A request sent to an anycast address for a certain service is routed to the nearest server for that service by the routers in the network.

Discovering the nearest TURN server is beneficial.

However, when using an anycast address to send a data packet to a server, the data packet may be received by different servers at different specific addresses. That poses a problem for usage of TURN servers, since they are accessed frequently during a call and the TURN services must be provided the same server throughout the duration of a call.

Servers like STUN and TURN servers, may have defined responses for usage of alternative servers when being accessed to provide their service, but those responses are used for overload situations, load balancing or unavailability of the requested service.

### SUMMARY

In one aspect, a method for finding a specific address of a server in a data communication network when using anycast addressing defined for available servers that provide a predetermined service comprises providing a first server having a memory and a processor coupled to the memory, sending a request from a client to use the first server for the predetermined service by the anycast address of the service, receiving the request at the first server and detecting that the request was addressed using an anycast address, and sending a response to the client, instructing the client to use an alternative server and providing a specific address of the alternative server to the client, instead of providing the requested predetermined service by the first server in response to the request.

In another aspect, the alternative server and the first server comprise a combined server, and the requested predetermined service is provided in response to a request from the client to the specific address, and the specific address is the same for the first server and the alternative server.

In another aspect, the method for finding a specific address of a server in a data communication network detects that the request was addressed using the specific address, and sends a response to the client instructing the client to use a second predetermined service by providing a specific address of the server itself.

In another aspect, the predetermined service is Traversal Using Relays around NAT (TURN) service.

In another aspect, the predetermined service is Session Traversal Utilities for NAT (STUN) and the second predetermined service is a TURN service.

In another aspect, Web browser or an application implements a client side of the method for finding a specific address of a server in a data communication network.

In another aspect, a telecommunication device implements a client side of the method for finding a specific address of a server in a data communication network.

In another aspect, a telecommunication device implements a server side of the method for finding a specific address of a server in a data communication network.

In another aspect, a system for telecommunication implements the method for finding a specific address of a server in a data communication network.

In another aspect, a software module incorporated into a telecommunication device implements the method for finding a specific address of a server in a data communication network.

In another aspect, a device for telecommunication is configured to find a specific address of a server in a data communication network when using anycast addressing defined for available servers that provide a predetermined service, and the device comprises a memory, a processor coupled to the memory, and a client for using a server and configured to send a request from the client to use a first server for the predetermined service by the anycast address of the service, receive a response from the first server instructing the client to use an alternative server at a specific, and use the alternative server at the specific address by the client.

In another aspect, the device is a Web browser or an application.

In another aspect, a server for telecommunication is configured to provide a predetermined service by usage of anycast addressing for discovering available servers at specific addresses in a data communication network, and the server comprises a memory, and a processor coupled to the memory and configured to receive a request from a client to use the server for the predetermined service by the anycast address of the service, detect that the request was addressed using an anycast address, send a response to the client, and instruct the client to use this server at its specific address, instead of providing the requested predetermined service, and provide the requested predetermined service at subsequent requests to its specific address.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use of the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 shows a system for telecommunication according to an embodiment;

FIG. 2 shows a process for finding a specific address of a server in a data communication network according to another embodiment; and

FIG. 3 shows a system for telecommunication according to another embodiment.

### DETAILED DESCRIPTION OF THE PREFERRED EMBODIMENTS

A method of accessing a server for services at a specific address, even though the server is discovered using anycast addressing, is proposed. Anycast addressing in itself may result in that the service is provided by different servers at subsequent accesses of the service, which will not function with some type of services, e.g. the NAT and firewall traversal services provided by a TURN server that relay real-time traffic between telecommunicating endpoints for the duration of a call.

In one proposed method the server being addressed by an anycast address, does not provide the requested service, but responds with the specific address of the server to use. The client detects that a specific address is received in the response, even though anycast addressing was used for the request, and can thereby request the service at the specific address in the response for subsequent accesses of the service.

In a further proposed method, the server being addressed at a specific address may propose a second service to be used, by returning a response with the specific address of the server itself. The client detects that the specific address received in the response is the same as the request was sent to, and thereby can request usage of the second service.

A data communication network is typically a packet switch network like the Internet, forwarding packets of data to destinations defined by the address of the packets. Data packets may be requests, responses, or data representing documents, files, media like movies, voice and more.

A specific address in a network may be a number (like an IPv4 or an IPv6 address) or a symbolic address (like a Fully Qualified Domain Name (FQDN) that is further resolved into a number address, e.g. by a DNS service. The specific address specifies the network interface of which an endpoint is connected to and which data addressed to the specific address is sent to.

Anycast addressing uses a network address defined for a predetermined service. The network is set up to forward data to servers performing the predetermined service. On the Internet, such forwarding is done by network routers. As data packets propagate through the network, routers having knowledge of the specific addresses at which such servers are located, forward the packets to such servers.

Finding servers for IPv4 to IPv6 transitioning is an example of a service on the Internet using anycast addressing.

Session Traversal Utilities for NAT (STUN) and Traversal Using Relays around NAT (TURN) are services that could be assigned anycast addresses on the Internet.

STUN and TURN servers are used to assist real-time traffic to traverse NATs and firewalls in the network.

Real-time traffic, may be data packets representing streams of voice or other media streams resulting from a call over the Internet.

STUN servers are e.g. used by clients to learn the public outside address of a NAT or firewall forwarding data packets.

A TURN server is an extension to a STUN server, that also is able to relay or forward real-time traffic between endpoints.

Endpoints are clients or servers using a particular application or service, e.g. telephony over Internet, also called Voice over IP (VoIP).

A web browser is a program running on computers or smartphones for accessing services on the World Wide Web (the web).

An application is a program running on computers or smartphones that provides a function or a service.

A server is a network device that is accessed by clients and provides a service or a function.

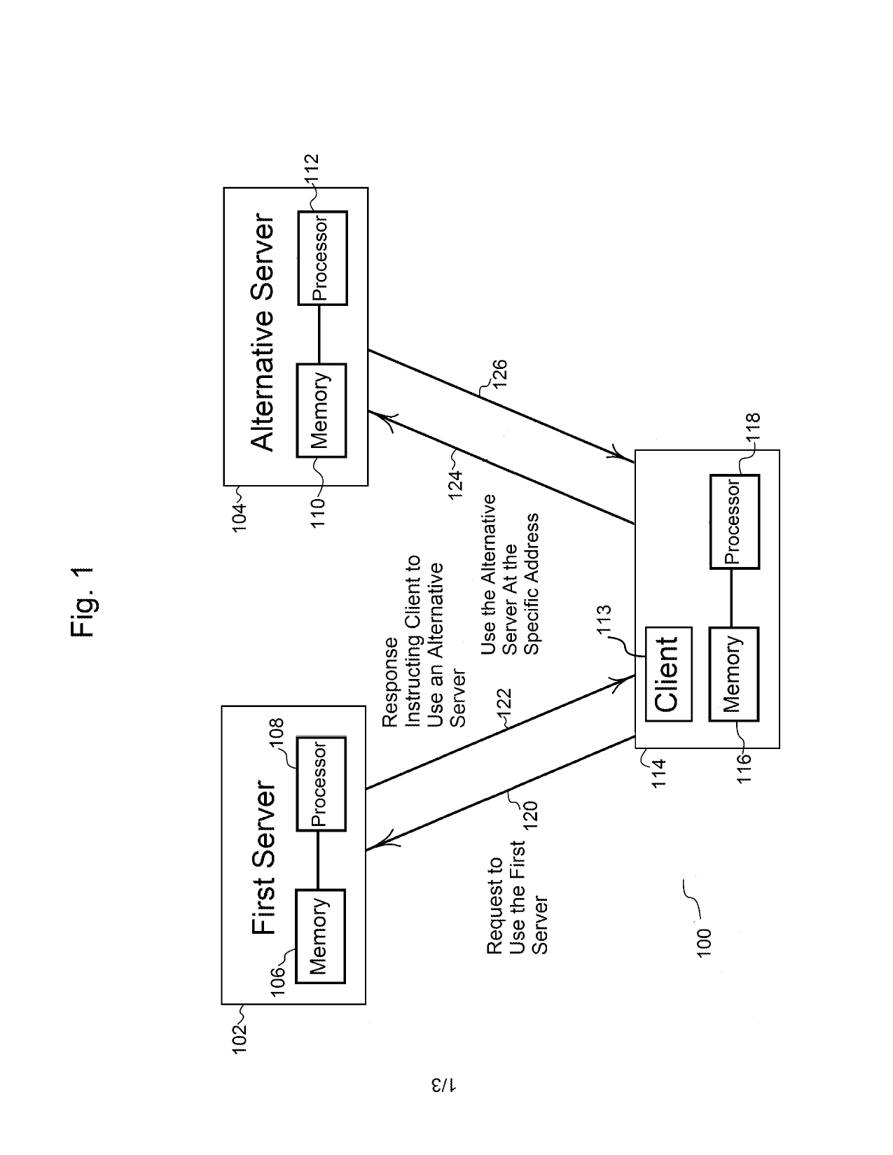

A system for telecommunication 100 according to an embodiment is shown in FIG. 1.

The system 100 may be configured to find a specific address of a server in a data communication network when using anycast addressing defined for available servers that provide a predetermined service. In one embodiment, the predetermined service may be a Traversal Using Relays around NAT (TURN) service.

The system 100 may include a device 114 including a client 113. The client 113 may be coupled to a first server 102 and an alternative server 104. In one embodiment, the device 114 may be a web browser or an application.

The device 114 may have a memory 116 and a processor 118 coupled to the memory 116. The first server 102 may have a memory 106 and a processor 108 coupled to the memory 106. The alternative server 104 may have a memory 110 and a processor 112 coupled to the memory 110.

The client 113 may send a request 120 to use the first server 102 for the predetermined service by the anycast address of the service. The client 113 may receive a response from the first server 102 instructing the client 113 to use an alternative server 104 at a specific address. The client 113 may use the alternative server 104 at the specific address.

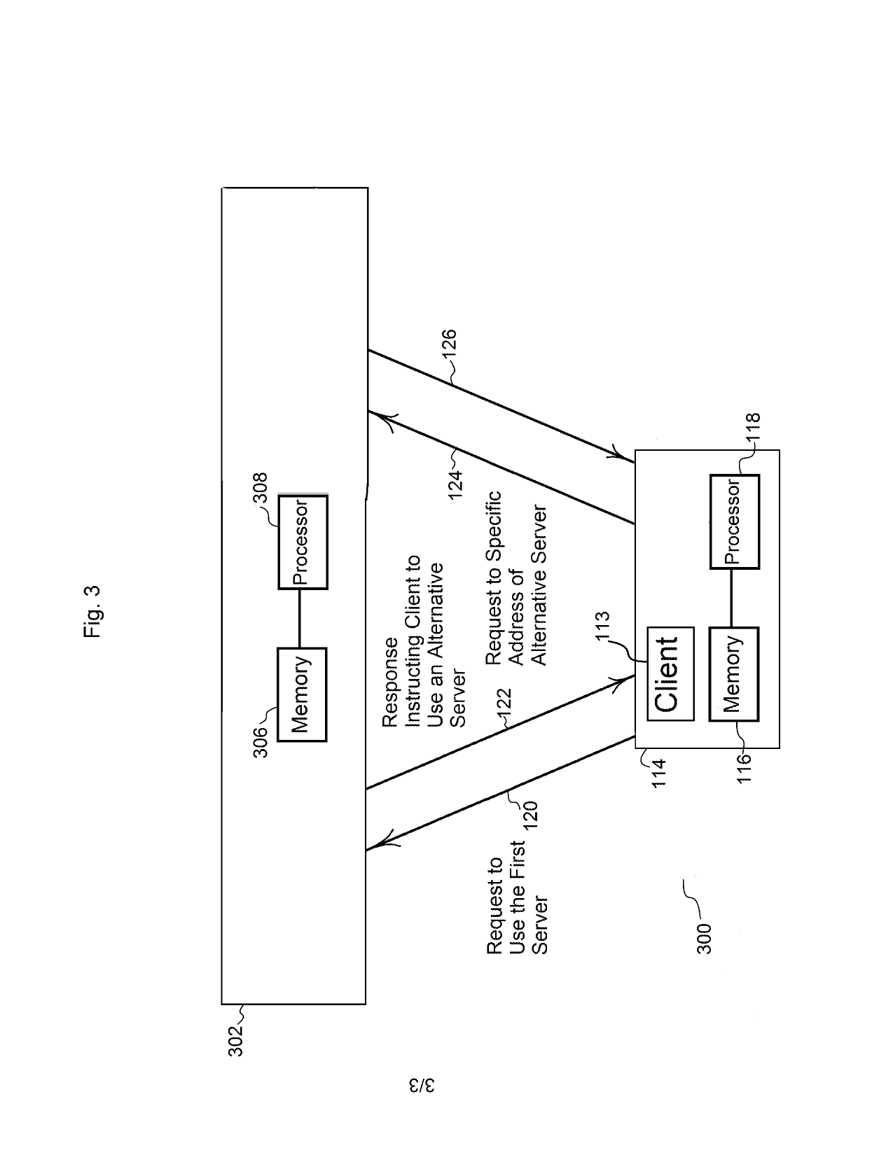

In one embodiment, as shown in FIG. 3, the alternative server and the first server may be a combined server 302, in a system 300, and the requested predetermined service may be provided by the combined server 302 in as may be confirmed by response 126 to a request 124 from the client to the specific address of the combined server 302. The specific address of the combined server may be the same as for the first server and the alternative server.

The combined server 302 may receive a request from the client 113 to use the combined server 302 for the predetermined service by the anycast address of the service. The combined server 302 may detect that the request was addressed using an anycast address. The combined server 302 may send a response to the client 113, instructing the client 113 to use this combined server 302 added specific address, instead of providing the requested predetermined service. The combined server 302 may provide the requested predetermined service at subsequent request to its specific address.

In another embodiment, referring again to FIG. 1, the first server 102 may detect that the request 120 was addressed using the specific address, and send a response 122 to the client 113 instructing the client 113 to use a second predetermined service by providing a specific address of the first server 102.

In another embodiment, still referring to FIG. 1, the alternative server 104 may detect that the request 124 was addressed using the specific address, and send a response 126 to the client 113 instructing the client 113 to use a second predetermined service by providing a specific address of the alternative server 104.

In another embodiment, the predetermined service may be Session Traversal Utilities for NAT (STUN) and the second predetermined service may be a TURN service.

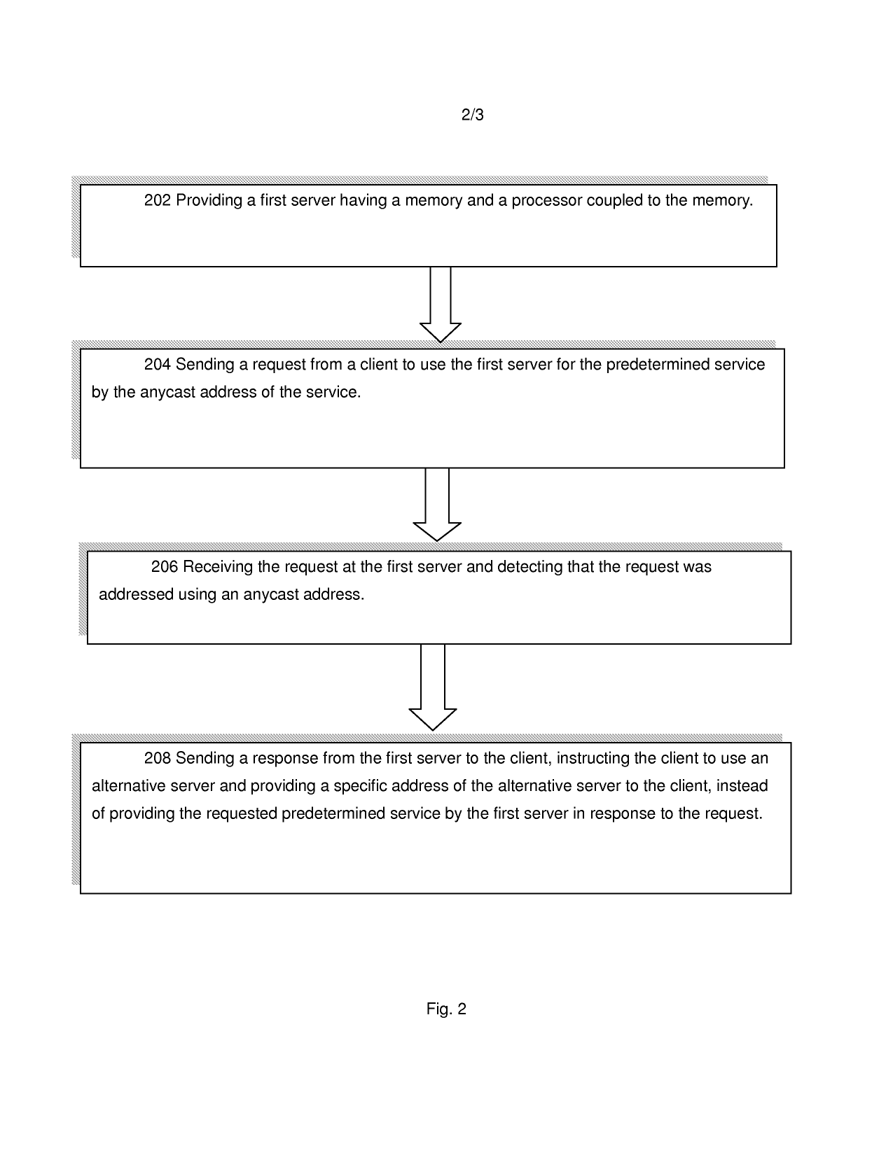

A process for finding a specific address of a server in a data communication network when using anycast addressing defined for available servers that provide a predetermined service is shown in FIG. 2. In an operation 202, a first server having a memory and a processor coupled to the memory is provided. In an operation 204, a request is sent from a client to use the first server for the predetermined service by the anycast address of the service. In an operation 206, the request is received at the first server and the first server detects that the request was addressed using an anycast address. In an operation 208, a response is sent to the client, instructing the client to use an alternative server and providing a specific address of the alternative server to the client, instead of providing the requested predetermined service by the first server in response to the request.

In a further operation the requested predetermined service may be provided by the alternative server in response to a request from the client to the specific address of the alternative server.

In a further operation, the request is detected to have been addressed using the specific address, and a response is sent to the client instructing the client to use a second predetermined service by providing a specific address of the server itself.

In one embodiment, a web browser or an application may implement the client side of the method for finding a specific address of a server in a data communication network.

In one embodiment, a telecommunication device may implement client side or the server side of the method for finding a specific address of a server in a data communication network.

In one embodiment, a system for telecommunication may implement the method for finding a specific address of a server in a data communication network.

In one embodiment, a software module incorporated into a telecommunication device may implement the client side or the server side of the method for finding a specific address of a server in a data communication network.

The embodiments can be implemented in computing hardware (computing apparatus) and/or software, such as (in a non-limiting example) any computer that can store, retrieve, process and/or output data and/or communicate with other computers. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method for finding a specific address of a server in a data communication network when using anycast addressing defined for available servers that provide a predetermined service, comprising:
providing a first server having a memory and a processor coupled to the memory;
sending a request from a client to use the first server for the predetermined service by the anycast address of the service;
receiving the request at the first server and detecting that the request was addressed using an anycast address; and
sending a response from the first server to the client, instructing the client to use an alternative server and providing a specific address of the alternative server to the client, instead of providing the requested predetermined service by the first server in response to the request.

2. The method for finding a specific address of a server in a data communication network of claim 1, wherein the alternative server and the first server comprise a combined server; and
further comprising providing the requested predetermined service in response to a request from the client to the specific address, wherein the specific address is the same for the first server and the alternative server.

3. The method for finding a specific address of a server in a data communication network of claim 1, further comprising:
detecting that the request was addressed using the specific address; and
sending a response to the client instructing the client to use a second predetermined service by providing a specific address of the server itself.

4. The method for finding a specific address of a server in a data communication network of claim 1, wherein the predetermined service is Traversal Using Relays around NAT (TURN) service.

5. The method for finding a specific address of a server in a data communication network of claim 3, wherein the predetermined service is Session Traversal Utilities for NAT (STUN) and the second predetermined service is a TURN service.

6. A Web browser or an application implementing a client side of the method for finding a specific address of a server in a data communication network of claim 1.

7. A telecommunication device implementing a client side of the method of claim 1.

8. A telecommunication device implementing a client side of the method of claim 2.

9. A telecommunication device implementing a client side of the method of claim 3.

10. A telecommunication device implementing a server side of the method of claim 1.

11. A telecommunication device implementing a server side of the method of claim 2.

12. A telecommunication device implementing a server side of the method of claim 3.

13. A system for telecommunication implementing the method of claim 1.

14. A system for telecommunication implementing the method of claim 2.

15. A system for telecommunication implementing the method of claim 3.

16. A software module incorporated into a telecommunication device implementing the method of claim 1.

17. A software module incorporated into a telecommunication device implementing the method of claim 2.

18. A software module incorporated into a telecommunication device implementing the method of claim 3.

19. A device for telecommunication configured to find a specific address of a server in a data communication network when using anycast addressing defined for available servers that provide a predetermined service, comprising:
a memory;
a processor coupled to the memory; and
a client for using a server and configured to:
send a request from the client to use a first server for the predetermined service by the anycast address of the service;
receive a response from the first server instructing the client to use an alternative server at a specific address; and
use the alternative server at the specific address by the client.

20. The device for telecommunication of claim 16, wherein the device is a Web browser or an application.

21. A server for telecommunication configured to provide a predetermined service by usage of anycast addressing for discovering available servers at specific addresses in a data communication network, comprising:
a memory; and
a processor coupled to the memory and configured to:
receive a request from a client to use the server for the predetermined service by the anycast address of the service;
detect that the request was addressed using an anycast address;
send a response to the client and instruct the client to use this server at its specific address, instead of providing the requested predetermined service; and
provide the requested predetermined service at subsequent requests to its specific address.
